(19) United States
(12) Patent Application Publication
(10) Pub. No.: US 2012/0013528 A1
(43) Pub. Date: Jan. 19, 2012

(54) Distance measurment module, display device having the same, and distance measurement method of display device

(75) Inventors: Byung Hoon Kim, Suwon (KR); Jong-Woo Park, Seoul (KR)

(73) Assignee: Samsung Electro-Mechanics Co., Ltd., Suwon (KR)

(21) Appl. No.: 13/064,120

(22) Filed: Mar. 7, 2011

(30) Foreign Application Priority Data
Jul. 15, 2010 (KR) 10-2010-0068413

(51) Int. Cl. G09G 5/00; G01C 3/08

(52) U.S. Cl. 345/156; 356/5.1

(57) ABSTRACT

A distance measurement module includes: an image pickup lens capturing an image of a subject; a light source unit disposed to be adjacent to the image pickup lens and irradiating reference light to the subject; a light receiving unit extracting image information of the subject and distance information to the subject upon receiving light which is reflected from the subject and made incident through the image pickup lens; and a calculation unit calculating the distance to the subject by using a phase difference between the reference light and the reflected light.

### CROSS-REFERENCE TO RELATED APPLICATIONS

This application claims the priority of Korean Patent Application No. 10-2010-0068413 filed on Jul. 15, 2010, in the Korean Intellectual Property Office, the disclosure of which is incorporated herein by reference.

### BACKGROUND OF THE INVENTION

1. Field of the Invention

The present invention relates to a distance measurement module, a display device having the same, and a distance measuring method for the display device, and more particularly, to a distance measurement module for measuring the distance to a subject by making light, which is irradiated to the subject, a distance measurement target, and reflected from the subject, pass through an image pickup lens, a display device having the same, and a distance measuring method for the display device.

2. Description of the Related Art

In general, a distance measurement system for measuring the distance to an object (namely, the distance between the distance measurement system and the object) by using light, such as laser light, measures the distance to the object by using a method of measuring a time of flight (TOF) of light or by using a position sensitive device (PSD) method using the fact that the angle of a light beam reflected from a remote object and that of a light beam reflected from a near object are different.

When the distance measurement system measures the distance by measuring the TOF of light, the distance measurement system measures the TOF of light between a point in time at which a light source irradiates reference light for a distance measurement and a point in time at which an optical sensor detects reflected light generated as the reference light is reflected from a measurement target object to thus measure the distance.

In general, an optical system for a distance measurement using a laser includes a light source unit for transmitting light to a subject and a light receiving unit for concentrating light diffused from the subject, and usually uses a visible light laser.

However, the related art visible light laser may be harmful to a user's eye sight, and thus, cannot be readily applied to an electronic device such as a personal mobile terminal or the like.

In addition, when the distance to the near subject is measured, there is a need to measure distances to several points of the subject, so a measurement of distance to one point of the subject, according to a change in one point of the subject needs to be free.

Also, research into a method of simultaneously capturing an image of the subject and measuring the distance to the subject, and a method of measuring the distance to the subject by using the image of the subject is urgently required.

### SUMMARY OF THE INVENTION

An aspect of the present invention provides a distance measurement module for measuring a distance to a subject, i.e., a distance measurement target, by making light, which is irradiated to the subject, and reflected from the subject, passed through an image pickup lens, and measuring an image and a distance by using a single light receiving unit, a display device having the same, and a distance measuring method for the display device.

According to an aspect of the present invention, there is provided a distance measurement module including: an image pickup lens capturing an image of a subject; a light source unit disposed to be adjacent to the image pickup lens and irradiating reference light to the subject; a light receiving unit extracting image information of the subject and distance information to the subject upon receiving light which is reflected from the subject and made incident through the image pickup lens; and a calculation unit calculating the distance to the subject by using a phase difference between the reference light and the reflected light.

The calculation unit may include a noise canceller canceling noise in the reflected light.

The calculation unit may include an offset canceller canceling an offset of the reflected light.

The calculation unit may include a phase shift detection unit comparing the phase of the reflected light and that of the reference light.

The calculation unit may calculate the distance to the subject by a conditional expression 1 shown below:

$$D = \frac{c}{4 π f} Φ \qquad [ Conditional expression 1 ]$$

Here, D is the distance to the subject, C is the speed of reference light and reflected light, f is the number of vibrations of the reference light and the reflected light, and φ is a phase difference between the reference light and the reflected light.

The light receiving unit may include an image light receiving unit receiving a visible light area of the reflected light and converting the same into an electrical signal to extract image information, and a distance light receiving unit receiving an infrared area of the reflected light and converting the same into an electrical signal to extract distance information.

The image light receiving unit may include N*M pixels, and at least one distance light receiving unit may be formed at a lower side of the plurality of adjacent pixels, wherein N and M are natural numbers.

The module may further include: an optical pointing unit disposed to pass through the image pickup lens and be pointed to the subject.

The optical pointing unit may be a laser light source having a visible light band range.

According to another aspect of the present invention, there is provided a display device including: an image pickup lens capturing an image of a subject; a light source unit disposed to be adjacent to the image pickup lens and irradiating reference light to the subject; a light receiving unit extracting image information of the subject and distance information to the subject upon receiving light which is reflected from the subject and made incident through the image pickup lens; a calculation unit calculating the distance to the subject by using a phase difference between the reference light and the reflected light; and a display unit displaying the image information and the distance to the object obtained by the light receiving unit.

The calculation unit may include a noise canceller canceling noise in the reflected light.

The calculation unit may include an offset canceller canceling an offset of the reflected light.

The calculation unit may include a phase shift detection unit comparing the phase of the reflected light and that of the reference light.

The calculation unit may calculate the distance to the subject by a conditional expression 1 shown below:

$$D = \frac{c}{4 π f} Φ \qquad [ Conditional expression 1 ]$$

Here, D is the distance to the subject, C is the speed of reference light and reflected light, f is the number of vibrations of the reference light and the reflected light, and Φ is a phase difference between the reference light and the reflected light.

The light receiving unit may include an image light receiving unit receiving a visible light area of the reflected light and converting the same into an electrical signal to extract image information, and a distance light receiving unit receiving an infrared area of the reflected light and converting the same into an electrical signal to extract distance information.

The image light receiving unit may include N*M pixels, and at least one distance light receiving unit may be formed at a lower side of the plurality of adjacent pixels, wherein N and M are natural numbers.

The display device may further include: a controller controlling the display unit to be converted into an image capture mode in which an image of the subject is captured or a distance measurement mode in which one point of the image of the subject is designated.

The controller may control the calculation unit to calculate a phase difference between the reflected light and the reference light at one point of the subject corresponding to one point of the image of the subject.

The one point of the subject may be changeable in the image of the subject.

The display unit displays a discernment indication corresponding to one point of the image of the subject.

The display device may further include: an optical pointing unit disposed to pass through the image pickup lens and be pointed to the subject.

The optical pointing unit may be a laser light source having a visible light band range.

According to another aspect of the present invention, there is provided a distance measuring method for a display device, including: irradiating reference light to a subject and receiving light reflected from the subject by a light receiving unit; displaying an image extracted from a visible light area of the reflected light which has been received by the light receiving unit and extracting an infrared area of the reflected light to extract the phase of the reflected light; calculating the distance to the subject by using the phase difference between the phase of the reflected light and that of the reference light; and displaying the calculated distance information to the subject on an extracted image.

The calculating of the distance to the subject may include: canceling noise in and offset of the reflected light, detecting a phase shift of the noise and offset-canceled reference light and that of the reference light, and comparing the phases.

In calculating the distance to the subject, the distance to the subject may be calculated by a conditional expression 1 shown below:

$$D = \frac{c}{4 π f} Φ \qquad [ Conditional expression 1 ]$$

Here, D is the distance to the subject, C is the speed of reference light and reflected light, f is the number of vibrations of the reference light and the reflected light, and φ is a phase difference between the reference light and the reflected light.

The light receiving unit may include an image light receiving unit receiving a visible light area of the reflected light and converting the same into an electrical signal to extract image information, and a distance light receiving unit receiving an infrared area of the reflected light and converting the same into an electrical signal to extract distance information.

The phase of the reflected light may be that reflected from the reference light from one point of the subject corresponding to one point of the image of the subject.

The one point of the subject may be changeable in the image of the subject.

The display unit may display a discernment indication corresponding to one point of the image of the subject.

The method may further include: making a laser light resource of a visible light band range be pointed to the subject.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of an electronic device including a distance measurement module according to an exemplary embodiment of the present invention;

FIG. 2 is a schematic view showing an internal configuration of the distance measurement module and an output of reference light and incidence of reflected light according to an exemplary embodiment of the present invention;

FIG. 3 is a flow chart detailing a method for obtaining reference light for the distance measurement module, the phase of reflected light, and the distance to a subject according to an exemplary embodiment of the present invention;

FIG. 4 is a schematic plan view of a light receiving unit provided to the distance measurement module according to an exemplary embodiment of the present invention;

FIG. 5 is a schematic sectional view of the light receiving unit of the distance measurement module according to an exemplary embodiment of the present invention;

FIG. 6a is a schematic front view showing an image capture mode of a display device according to an exemplary embodiment of the present invention;

FIG. 6b is a schematic front view showing a distance measurement mode of a display device according to an exemplary embodiment of the present invention;

FIG. 6c is a schematic front view showing an optical point mode of a display device according to an exemplary embodiment of the present invention; and

FIGS. 7 and 8 are flow charts illustrating the process of a method for measuring a distance by a display device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like components.

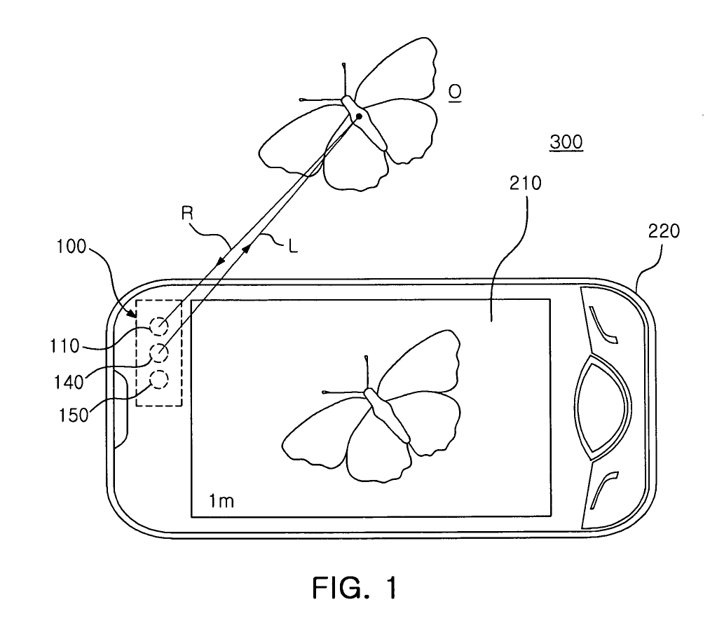

FIG. 1 is a schematic perspective view of an electronic device including a distance measurement module according to an exemplary embodiment of the present invention.

With reference to FIG. 1, an electronic device including a distance measurement module according to an exemplary embodiment of the present invention may include a distance measurement module 100 and a display unit 210.

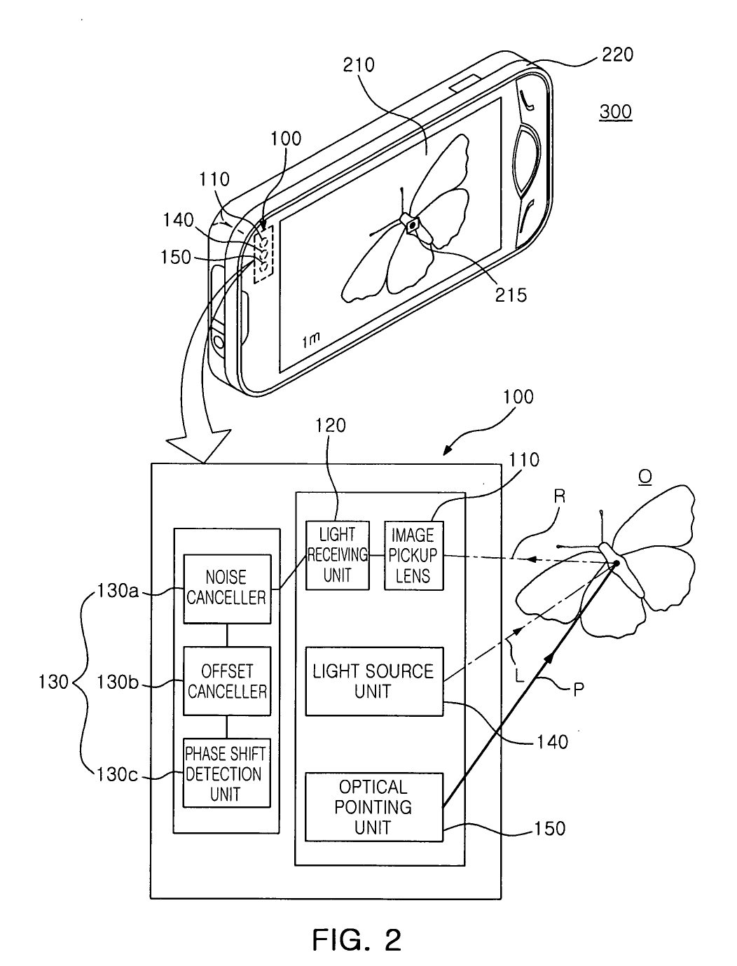

The distance measurement module 100 may include an image pickup lens 110, a light source unit 140 (See FIG. 2), a light receiving unit (See FIG. 2), and a calculation unit 130 (See FIG. 2), and may be positioned on either of a front surface or a rear surface of a mobile communication terminal 300, an electronic device.

The mobile communication terminal 300 is taken as an example of the electronic device according to the present exemplary embodiment, but the present invention is not limited thereto and a distance measurement device for only displaying a distance can be applicable.

The image pickup lens 110 is an optical lens that is able to capture an image of a subject (O), which may be disposed on an outer surface of a case 220 of the mobile communication terminal 300.

Image information of the subject (O) captured by the image pickup lens 110 can be displayed on a display unit 210 of the mobile communication terminal 300.

Distance information calculated by the distance measurement module 100 including the light source unit 140 and the light receiving unit 120 may be displayed on the display unit 210.

The internal configuration and operational principle of the mobile communication terminal 300 will be described in detail with reference to FIGS. 2 to 5 as follows.

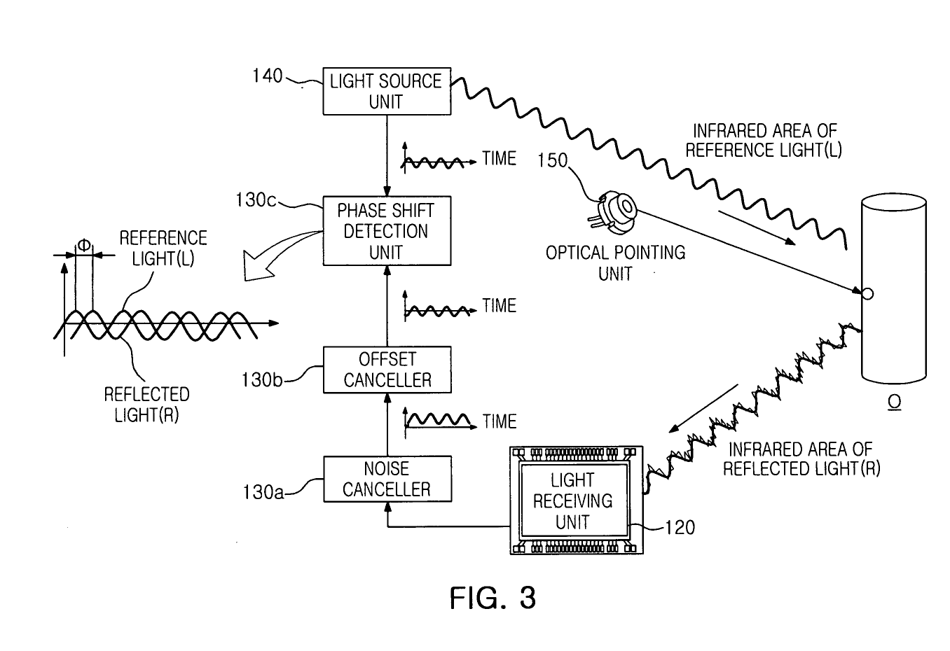

FIG. 2 is a schematic view showing an internal configuration of the distance measurement module and an output of reference light and incidence of reflected light according to an exemplary embodiment of the present invention, FIG. 3 is a flow chart detailing a method for obtaining reference light for the distance measurement module, the phase of reflected light, and the distance to a subject according to an exemplary embodiment of the present invention.

With reference to FIGS. 2 and 3, the distance measurement module 100 may include the image pickup lens 110, the light source unit 140, the light receiving unit 120, and the calculation unit 130.

The image pickup lens 110 is an optical lens for capturing an image of the subject (O). The reference light (L) output from the light source unit 140 reaches the subject (O) and is then reflected from the subject (O), and in this case, the light reflected from the subject (O) passes through the image pickup lens 110 to reach the light receiving unit 120.

The image pickup lens 110 may not be particularly limited, and any lens may be used, so long as it can allow light to pass therethrough to extract an image.

The light source unit 140 may be disposed to be adjacent to the image pickup lens 110, and irradiate the reference light (L) to the subject (O). Here, the light source unit 140 may irradiate both light of a visible light area and light of an infrared area to the subject (O), which can be absorbed by the light receiving unit 120 (to be described).

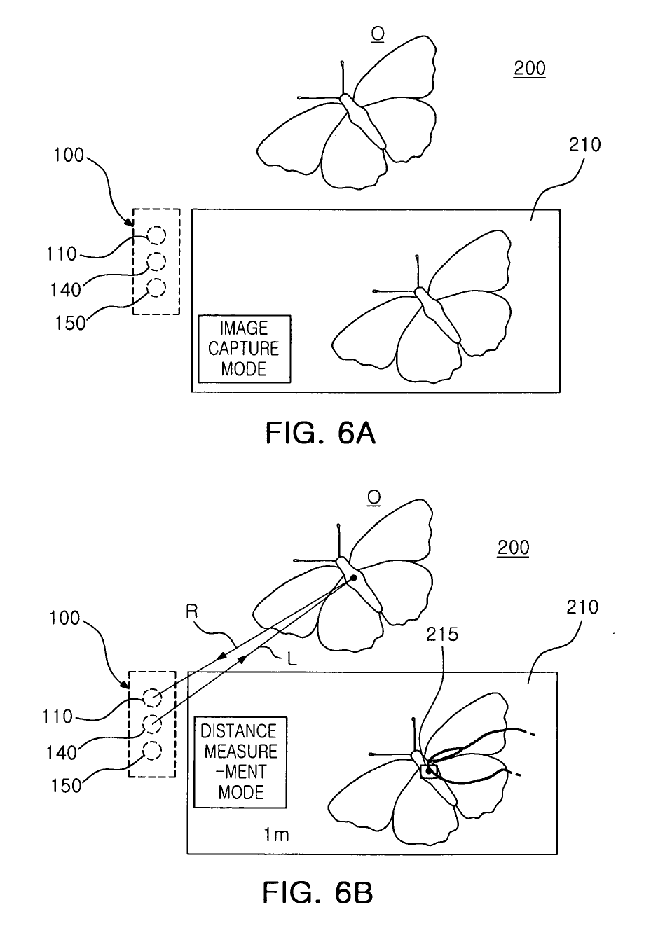

Namely, light of the visible light area providing image information and light of an infrared area providing distance information may be received by the light receiving unit 120 including the image light receiving unit 122 (See FIG. 5) and a distance light receiving unit 124 (See FIG. 5), and the image of the subject (O) and the distance to the subject (O) can be simultaneously provided to the display unit 210.

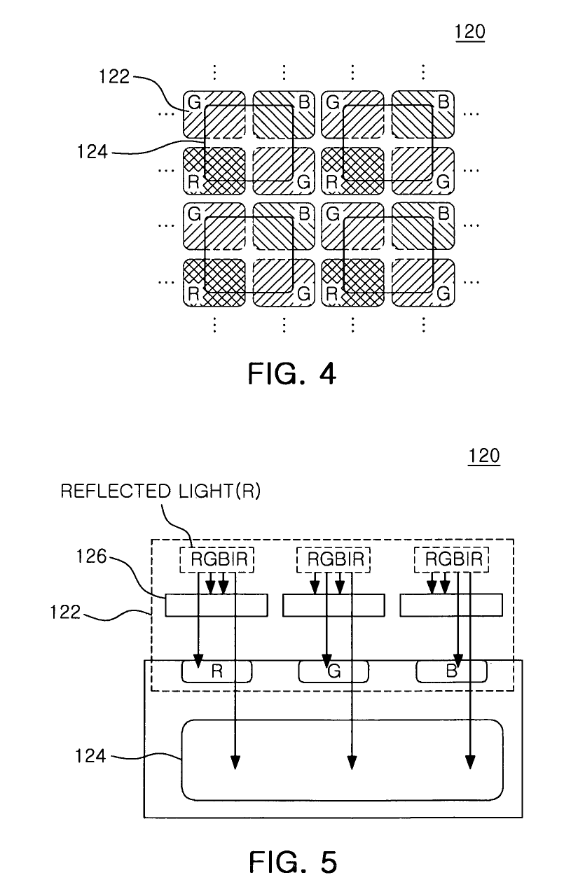

Here, the light receiving unit 120 will be described in more detail later with reference to FIGS. 4 and 5.

The light source unit 140 may irradiate only light of the infrared area, and in this case, the light of the infrared area may be light of 900 nm or higher that do not affect the vision.

Also, the light source unit 140 may separately output light of the visible light area and light of the infrared area, and in this case, the light of the visible light area and light of the infrared area may be separately received by the light receiving unit 120.

The calculation unit 130 may compare the phase of reference light (L) and the phase of reflected light (R) in order to measure the distance to the subject (O).

In order to compare the phase of reference light (L) and the phase of reflected light (R), the calculation unit 130 may include a noise canceller 130a, an offset canceller 130b, and a phase shift detection unit 130c.

The noise canceller 130a may be configured to cancel noise in the reflected light (R) of the infrared area received by the light receiving unit 120, which serves to accurately compare the phase of reference light (L) and the phase of reflected light (R).

In other words, the infrared area (L) of the reference light irradiated from the light source unit 140 reaches the subject (O), and the infrared area (R) of the reflected light received by the light receiving unit 120 after being reflected from the subject (O) includes noise, so preferably, noise therein is canceled in order to accurately measure the distance to the subject (O) through the phase comparison.

The offset canceller 130b is configured to cancel an offset of the waveform obtained by canceling noise by the noise canceller 130a, which serves to accurately compare the phase of the reference light (L) and the phase of the reflected light (R).

The reference for the phase of the infrared area of the reflected light (R) is adjusted so as to be compared with the phase of the reference light (L), and thereafter, a phase difference Φ can be extracted by the phase shift detection unit 130c.

The phase shift detection unit 130c compares the phase of the reference light (L) and that of the reflected light (R) to obtain the phase difference Φ can be applied to the following conditional expression 1 shown below to obtain the distance to the subject (O).

$$D = \frac{c}{4 π f} Φ \qquad [ Conditional expression 1 ]$$

wherein D is the distance to the subject, C is the speed of the reference light and the reflected light, f is the number of vibrations of the reference light and the reflected light, and Φ is a phase difference between the reference light and the reflected light.

Thus, the distance (D) to the subject (O) can be extracted by substituting the phase difference Φ to the conditional expression 1 by the phase shift detection unit 130c.

The distance measurement module 100 according to an exemplary embodiment of the present invention may further include an optical pointing unit 150 for making the subject (O) be pointed.

The optical pointing unit 150 is not an essential element of the distance measurement module 100, but it points to the subject (O) to allow for the checking or recognizing of the location of the subject (O) visually.

The optical pointing unit 150 may be effective when the image of the subject (O) is not clear with the laser light source (P) of the visible light band range in darkness.

FIG. 4 is a schematic plan view of a light receiving unit provided to the distance measurement module according to an exemplary embodiment of the present invention, and FIG. 5 is a schematic sectional view of the light receiving unit of the distance measurement module according to an exemplary embodiment of the present invention.

With reference to FIGS. 4 and 5, the light receiving unit 120 provided to the distance measurement module 100 according to an exemplary embodiment of the present invention may include the image light receiving unit 122 and the distance light receiving unit 124.

The image light receiving unit 122 includes N*M number of pixels including green (G), blue (B), and red (R) pixels, and may have a Bayer format.

The respective G, B, and R pixels can be formed by an optical filter that allows only a particular wavelength to pass therethrough, and light of the infrared area can be received by the distance light receiving unit 120 (to be described).

In order to extract image information, the image light receiving unit 122 may receive the visible light area of the reflected light (R) and converts the same into an electrical signal, and the image light receiving unit 122 can provide an image to the display unit 210 by the electrical signal.

Here, at least one distance light receiving unit 124 may be formed at a lower side of the plurality of adjacent pixels of the image light receiving unit 120. The distance light receiving unit 124 may receive the infrared area of the reflected light (R) and convert it into an electrical signal.

In this case, over the electrical signal with respect to the infrared area of the reflected light (R) by the distance light receiving unit 120, the phase of the reference light (L) and that of the reflected light (R) are compared by the calculation unit 130, and the distance to the subject (O) is calculated by using the above-mentioned Conditional expression 1.

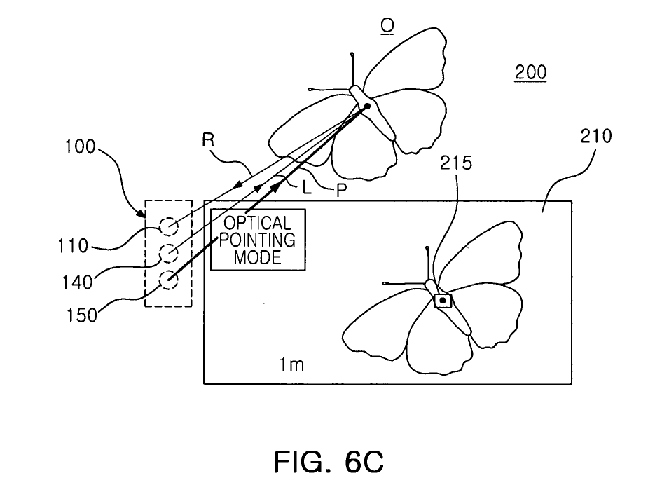

FIG. 6a is a schematic front view showing an image capture mode of a display device according to an exemplary embodiment of the present invention, FIG. 6b is a schematic front view showing a distance measurement mode of a display device according to an exemplary embodiment of the present invention, and FIG. 6c is a schematic front view showing an optical point mode of a display device according to an exemplary embodiment of the present invention.

With reference to FIGS. 6a to 6c, a display device 200 may include an image capture mode and a distance measurement mode.

The image capture mode is a mode in which an image of the subject (O) is displayed on the display unit 210. In the image capture mode, visible light area of light irradiated by the light source unit 140 is received by the image light receiving unit 122 of the light receiving unit 120, thus extracting an image.

In this case, in the image capture mode, an image can be displayed not only by the light irradiated by the light source unit 140 but also by sunlight.

The image of the subject (O) is displayed on the display unit in the image capture mode, and when the display device is changed into the distance measurement mode, one point 215 of the image of the subject (O) may be clicked.

When the one point 215 of the image of the subject (O) is clicked, reference light (L) is irradiated to the subject (O) by the light source unit 140 and light (R) reflected from the subject (O) is received by the light receiving unit 120 through the image pickup lens 110.

With respect to the infrared area of the reflected light (R) received by the light receiving unit 120, the phase of the reference light (L) and that of the reflected light (R) are compared by the calculation unit 130 to obtain the distance to the subject (O), and the obtained distance is displayed on a certain area of the display unit 210.

Also, when another point of the image of the subject (O) displayed on the display unit 210 is clicked, the distance to the another point of the subject (O) is calculated through the foregoing sequential process and then displayed on the display unit 210.

Here, the conversion between the image capture mode and the distance measurement mode may be executed by a controller (not shown), and the controller (not shown) may control the calculation unit 130 to calculate the phase difference between the reflected light (R) at one point of the subject (O) corresponding to the one point 215 of the image of the subject (O).

Also, the one point of the subject (O) can be changeable within the image of the subject (O) displayed on the display unit 210, and the distance to the changed one point of the subject (O) can be expressed on the display unit 210.

Here, the display unit may include an optical pointing mode. The optical pointing mode can point to the subject (O) desired to be obtained by the laser light source in the visible light band range to allow checking of the location of the subject (O) visually.

The optical pointing mode is a supplementary mode for measuring the distance to the subject (O), rather than an essential configuration.

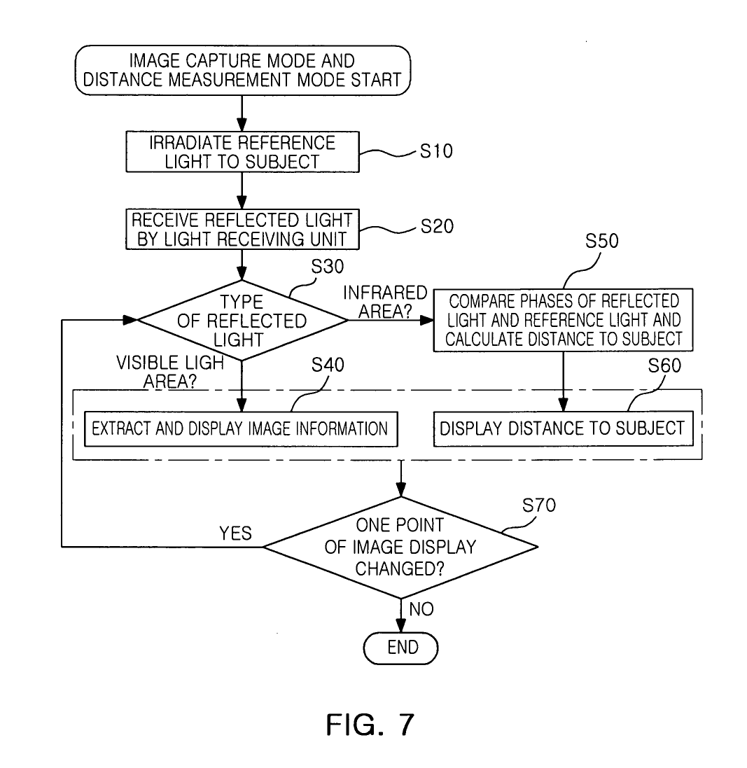

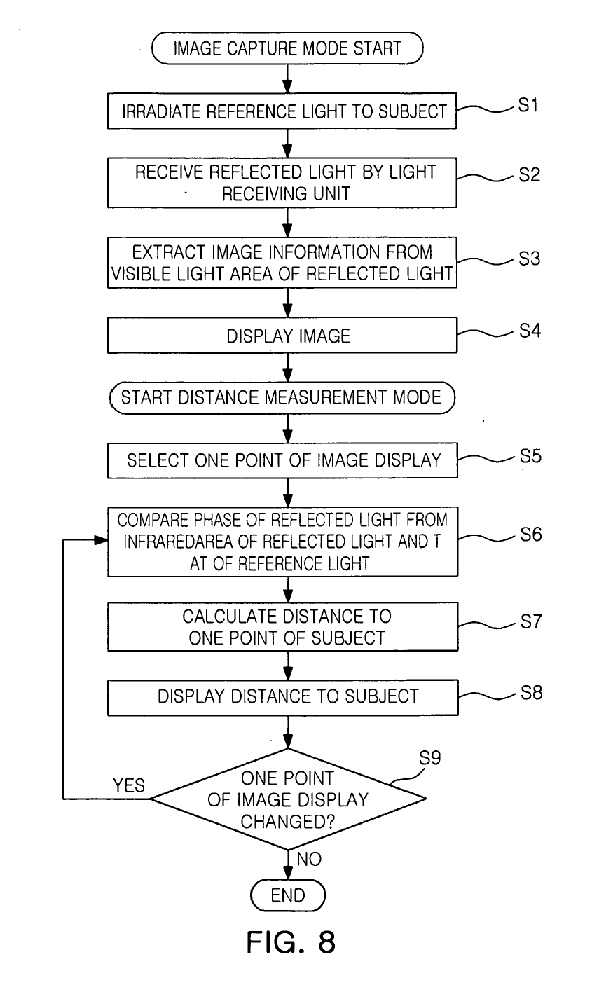

FIGS. 7 and 8 are flow charts illustrating the process of a method for measuring a distance by a display device according to an exemplary embodiment of the present invention. The distance measurement method will now be described with reference to FIGS. 7 and 8.

First, with reference to FIG. 7, when the image capture mode and the distance measurement mode starts, the light source unit 140 irradiates reference light (L) to the subject (O) (S10).

The reference light (L) is reflected from the subject (O) and received by the light receiving unit 120 through the image pickup lens 110 (S20), and in this case, the visible light area and the infrared area of the reflected light (R) can be received by the image light receiving unit 122 and the distance light receiving unit 124, respectively.

That is, the light receiving unit 120 is divided into the image light receiving unit 122 for receiving the visible light area of the reflected light (R) and the distance light receiving unit 124 for receiving the infrared area of the reflected light (R) (S30), the visible light area of the reflected light (R) is converted into an electrical signal by the image light receiving unit 122 and displayed on the display unit 210 (S40), and as for the infrared area of the reflected light (R), the phase of the reflected light (R) and that of the reference light (L) are compared by the calculation unit 130 to extract the distance (D) to the subject (O) (S50).

Thereafter, the distance to the subject (O) is displayed on the display unit 210 (S60), thus achieving the purpose of the present invention.

When one point of the image of the subject (O) displayed on the display unit 210 is changed, reflected light (R) corresponding to a pertinent one point of the subject is made incident to the light receiving unit 120, and the distance to the one point of the subject (O) can be obtained through the sequential process as described above.

Thus, in the present exemplary embodiment of the present invention, the image of the subject (O) and the distance to the subject (O) can be simultaneously extracted by using the visible light area and the infrared area of the light source unit 140, and thereafter, one point of the image of the subject (O) may be changed and the distance to the changed one point of the subject (O) can be obtained.

With reference to FIG. 8, the image capture mode and the distance measurement mode are separately provided. When the image capture mode starts first, the light source unit 140 outputs reference light to the subject (O) (S1).

The reference light (L) is reflected from the subject (O) and received by the light receiving unit 120 through the image pickup lens 110 (S2), and in this case, the visible light area and the infrared area of the reflected light (R) are received by the image light receiving unit 122 and the distance light receiving unit 120, respectively.

In this case, in case of the image capture mode, image information is extracted from the visible light area of the reflected light (R) and displayed on the display unit 210 (S4), and the image of the subject (O) can be expressed on the display unit 210.

Thereafter, when the image capture mode is changed into the distance measurement mode, one point of the image on the display unit 210 is clicked (S5), the infrared area of the reflected light (R) corresponding to the reference light (L) irradiated from the light source unit 140 is received by the distance light receiving unit 124 of the light receiving unit 120, and the phase of the reference light (L) and that of the reflected light (R) are compared (S6).

Subsequently, the distance is calculated by the calculation unit 130 (S7) and displayed on the display unit (S8), and thereafter, the one point of the image of the subject (O) displayed on the display unit 210 may be changed (S9).

The phase of the reflected light (R) with respect to one point of the subject corresponding to the changed one point of the image of the subject (O) and that of the reference light (L) may be compared again, and the distance to the changed one point may be displayed on the display unit 210.

Also, the optical point unit 150, a supplementary element of the present invention, can be employed in any stage. The optical point unit 150 may point to the subject (O) desired to be obtained through a laser light source of a visible light band range, to allow for the checking or recognizing of the location of the subject (O) visually.

As set forth above, in the distance measurement module, the display device having the same, and the distance measuring method for the display device according to exemplary embodiments of the invention, because image information and distance information are extracted by using a single light receiving unit including the image light receiving unit 122 and the distance light receiving unit 124, the distance measurement module can be reduced in size.

Also, because the distance to a subject is calculated by comparing the phase of reference light and that of reflected light with respect to the subject, the accuracy of the distance calculation can be improved.

In addition, because the distance to the subject is measured according to a change of one point of a displayed image of the subject, the distance to the subject located in a near position can be accurately measured in the units of one point (namely, one point by one point).

While the present invention has been shown and described in connection with the exemplary embodiments, it will be apparent to those skilled in the art that modifications and variations can be made without departing from the spirit and scope of the invention as defined by the appended claims.

What is claimed is:

1. A distance measurement module comprising:
an image pickup lens capturing an image of a subject;
a light source unit disposed to be adjacent to the image pickup lens and irradiating reference light to the subject;
a light receiving unit extracting image information of the subject and distance information to the subject upon receiving light which is reflected from the subject and made incident through the image pickup lens; and
a calculation unit calculating the distance to the subject by using a phase difference between the reference light and the reflected light.

2. The module of claim 1, wherein the calculation unit comprises a noise canceller canceling noise in the reflected light.

3. The module of claim 1, wherein the calculation unit comprises an offset canceller canceling an offset of the reflected light.

4. The module of claim 1, wherein the calculation unit comprises a phase shift detection unit comparing the phase of the reflected light and that of the reference light.

5. The module of claim 1, wherein the calculation unit calculates the distance to the subject by a conditional expression 1 shown below:
$$D = \frac{c}{4 π f} Φ \qquad [ Conditional expression 1 ]$$
wherein D is the distance to the subject, C is the speed of reference light and reflected light, f is the number of vibrations of the reference light and the reflected light, and Φ is a phase difference between the reference light and the reflected light.

6. The module of claim 1, wherein the light receiving unit comprises an image light receiving unit receiving a visible light area of the reflected light and converting the same into an electrical signal to extract image information, and a distance light receiving unit receiving an infrared area of the reflected light and converting the same into an electrical signal to extract distance information.

7. The module of claim 6, wherein the image light receiving unit comprises N*M pixels, and at least one distance light receiving unit may be formed at a lower side of the plurality of adjacent pixels, wherein N and M are natural numbers.

8. The module of claim 1, further comprising: an optical pointing unit disposed to pass through the image pickup lens and be pointed to the subject.

9. The module of claim 8, wherein the optical pointing unit is a laser light source having a visible light band range.

10. A display device comprising:
an image pickup lens capturing an image of a subject;
a light source unit disposed to be adjacent to the image pickup lens and irradiating reference light to the subject;
a light receiving unit extracting image information of the subject and distance information to the subject upon receiving light which is reflected from the subject and made incident through the image pickup lens;
a calculation unit calculating the distance to the subject by using a phase difference between the reference light and the reflected light; and
a display unit displaying the image information and the distance to the object obtained by the light receiving unit.

11. The device of claim 10, wherein the calculation unit comprises a noise canceller canceling noise in the reflected light.

12. The device of claim 10, wherein the calculation unit comprises an offset canceller canceling an offset of the reflected light.

13. The device of claim 10, wherein the calculation unit comprises a phase shift detection unit comparing the phase of the reflected light and that of the reference light.

14. The device of claim 10, wherein the calculation unit calculates the distance to the subject by a conditional expression 1 shown below:
$$D = \frac{c}{4 π f} Φ \qquad [ Conditional expression 1 ]$$
wherein D is the distance to the subject, C is the speed of reference light and reflected light, f is the number of vibrations of the reference light and the reflected light, and Φ is a phase difference between the reference light and the reflected light.

15. The device of claim 10, wherein the light receiving unit comprises an image light receiving unit receiving a visible light area of the reflected light and converting the same into an electrical signal to extract image information, and a distance light receiving unit receiving an infrared area of the reflected light and converting the same into an electrical signal to extract distance information.

16. The device of claim 10, wherein the image light receiving unit comprises N*M pixels, and at least one distance light receiving unit is formed at a lower side of the plurality of adjacent pixels, wherein N and M are natural numbers.

17. The device of claim 10, further comprising: a controller controlling the display unit to be converted into an image capture mode in which an image of the subject is captured or a distance measurement mode in which one point of the image of the subject is designated.

18. The device of claim 17, wherein the controller controls the calculation unit to calculate a phase difference between the reflected light and the reference light at one point of the subject corresponding to one point of the image of the subject.

19. The device of claim 18, wherein the one point of the subject is changeable in the image of the subject.

20. The device of claim 19, wherein the display unit displays a discernment indication corresponding to one point of the image of the subject.

21. The device of claim 10, further comprising: an optical pointing unit disposed to pass through the image pickup lens and be pointed to the subject.

22. The device of claim 20, wherein the optical pointing unit is a laser light source having a visible light band range.

23. A distance measuring method for a display device, the method comprising:
irradiating reference light to a subject and receiving light reflected from the subject with a light receiving unit;
displaying an image extracted from a visible light area of the reflected light which has been received by the light receiving unit and extracting an infrared area of the reflected light to extract the phase of the reflected light;
calculating the distance to the subject by using the phase difference between the phase of the reflected light and that of the reference light; and
displaying the calculated distance information to the subject on an extracted image.

24. The method of claim 23, wherein the calculating of the distance to the subject comprises:
canceling noise in and offset of the reflected light, detecting a phase shift of the noise and offset-canceled reference light and that of the reference light, and comparing the phases.

25. The method of claim 23, wherein, in calculating the distance to the subject, the distance to the subject is calculated by a conditional expression 1 shown below:
$$D = \frac{c}{4 π f} Φ \qquad [ Conditional expression 1 ]$$
wherein D is the distance to the subject, C is the speed of reference light and reflected light, f is the number of vibrations of the reference light and the reflected light, and Φ is a phase difference between the reference light and the reflected light.

26. The method of claim 23, wherein the light receiving unit comprises an image light receiving unit receiving a visible light area of the reflected light and converting the same into an electrical signal to extract image information, and a distance light receiving unit receiving an infrared area of the reflected light and converting the same into an electrical signal to extract distance information.

27. The method of claim 23, wherein the phase of the reflected light is that reflected from the reference light from one point of the subject corresponding to one point of the image of the subject.

28. The method of claim 27, wherein the one point of the subject is changeable in the image of the subject.

29. The method of claim 27, wherein the display unit displays a discernment indication corresponding to one point of the image of the subject.

30. The method of claim 23, further comprising:
making a laser light resource of a visible light band range be pointed to the subject.
